(19) United States
(12) Patent Application Publication
(10) Pub. No.: US 2025/0370750 A1
(43) Pub. Date: Dec. 4, 2025

(54) UNALIGNED LOAD AND STORE IN A CORE

(71) Applicant: XILINX, INC., San Jose, CA (US)

(72) Inventors: Juan J. NOGUERA SERRA, San Jose, CA (US); Francisco BARAT QUESADA, Erembodegem (BE); Pedro Miguel Parola DUARTE, Skerries (IE); Luc De COSTER, Aalst (BE); Stephan MUNZ, Dublin (IE); Baris OZGUL, Dublin (IE)

(21) Appl. No.: 18/731,006

(22) Filed: May 31, 2024

(51) Int. Cl. G06F 9/30; G06F 9/38

(52) U.S. Cl. CPC G06F 9/30043; G06F 9/3013; G06F 9/3816

(57) ABSTRACT

Embodiments herein describe storing unaligned data structures in local memory that are then loaded into cores. For example, the data structures may have a length that is not a power of 2 so that they do not align with the width (or the bandwidth of the local memories). A load unit in the core can receive multiple data chunks from the local memory and identify an unaligned data structure that spans across the data chunks. The data structures can then be stored in a register as an aligned data structure as the width of the register may match the length of the data structure.

### TECHNICAL FIELD

Examples of the present disclosure generally relate to loading and storing unaligned data structures between local memory and a core.

### BACKGROUND

Typically, processor cores include load and store units that move data into and out of a core. That is, the load and store units serve as an interface between the core and local memory in the processor. The load units load data into registers where the data is then retrieved and processed by the core, such as by multiply and accumulate (MAC) circuitry. The processed data can then be stored in the memory using the store units.

The interface between the load/store units and the local memory is typically bit width of the power of 2 (e.g., 256 or 512). The data structures stored in the local memory are also a power of 2 (e.g., integers (INT) such as INT8/INT16 or floating point (FPs) such as FP16/FP32). As such, the bandwidth or width of the local memory typically aligns with the data structures being stored in the local memory.

### SUMMARY

One embodiment described herein is a processor that includes memory configured to store unaligned data structures and a load unit with circuitry configured to receive at least two data chunks from the memory using respective read cycles, identify an unaligned data structure within the at least two data chunks, and store the unaligned data structure in a register where the unaligned data structure spans across the at least two data chunks and does not align with the at least two data chunks. The processor also includes data processing circuitry in a core of the processor configured to retrieve the unaligned data structure from the register and process the unaligned data structure.

One embodiment described herein is a core that includes a load unit configured to retrieve data from a memory that stores unaligned data structures, the load unit including circuitry configured to receive at least two data chunks from the memory using respective read cycles, identify an unaligned data structure within the at least two data chunks, and store the unaligned data structure in a register, wherein the unaligned data structure spans across the at least two data chunks and does not align with the at least two data chunks. The core also includes data processing circuitry configured to retrieve the unaligned data structure from the register and process the unaligned data structure.

One embodiment described herein is a method that includes receiving, at a load unit, at least two data chunks from a memory using respective read cycles where the memory stores unaligned data structures, identifying an unaligned data structure within the at least two data chunks, storing the unaligned data structure in a register where the unaligned data structure spans across the at least two data chunks and does not align with the at least two data chunks, and retrieving the unaligned data structure from the register and processing the unaligned data structure using circuitry in a core.

### BRIEF DESCRIPTION OF DRAWINGS

So that the manner in which the above recited features can be understood in detail, a more particular description, briefly summarized above, may be had by reference to example implementations, some of which are illustrated in the appended drawings. It is to be noted, however, that the appended drawings illustrate only typical example implementations and are therefore not to be considered limiting of its scope.

FIG. 1 illustrates a processor system that uses unaligned data structures and memory, according to an example.

FIG. 2 illustrates retrieving unaligned data structure from memory, according to an example.

FIG. 3 is a flowchart for processing unaligned data structures in a core, according to an example.

FIG. 4 is a flowchart for processing data structures with a shared exponent in a core, according to an example.

FIG. 5 illustrates logic for retrieving unaligned data structures from a local memory, according to an example.

FIG. 6 illustrates logic for storing unaligned data structures into a local memory, according to an example.

FIG. 7 is a block diagram of a data processing engine, according to an example.

FIG. 8 is a block diagram of an AI engine array, according to an example.

To facilitate understanding, identical reference numerals have been used, where possible, to designate identical elements that are common to the figures. It is contemplated that elements of one example may be beneficially incorporated in other examples.

### DETAILED DESCRIPTION

Various features are described hereinafter with reference to the figures. It should be noted that the figures may or may not be drawn to scale and that the elements of similar structures or functions are represented by like reference numerals throughout the figures. It should be noted that the figures are only intended to facilitate the description of the features. They are not intended as an exhaustive description of the embodiments herein or as a limitation on the scope of the claims. In addition, an illustrated example need not have all the aspects or advantages shown. An aspect or an advantage described in conjunction with a particular example is not necessarily limited to that example and can be practiced in any other examples even if not so illustrated, or if not so explicitly described.

Embodiments herein describe storing unaligned data structures in local memory that are then loaded into cores. That is, the data structures may have a length that is not a power of 2 so that they do not align with the width (or the bandwidth of the local memories). For example, the memory may output 512 bits during a read cycle, but the data structures may have lengths greater than this, and are not a power of two (e.g., 640 or 704 bits). As such, the data read from the local memory cannot directly be stored in registers in the core, which may have widths that match the width of the data structures. This can arise with new types of data structures that have an exponent that is shared amongst multiple mantissas such as block floating points (BFP) and microscaling FPs (MXFP).

The embodiments herein describe logic in load and store units in a core of a processor that identify the various components in an unaligned data structure so they can be properly stored in a register in the core. Since the data structure can be larger than the data chunks being read from the memory, the logic may scan multiple data chucks (e.g., two or more 512 bit data chunks) to identify the starting bit of the mantissa, the starting bit of the shared exponent, and any other metadata in the data structure. In this manner, the data structure which is unaligned in the local memory can be aligned and stored in a register in the core. The data processing circuitry in the core (e.g., MAC circuitry) can then retrieve the data and process it. Once processed, the resulting data structure can again be stored as unaligned data in the local memory.

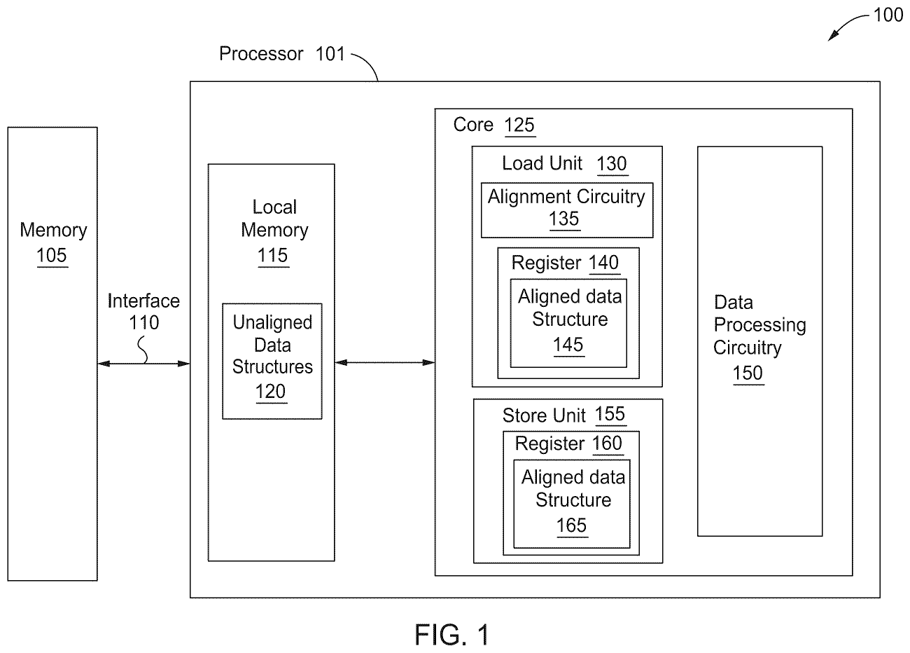

FIG. 1 illustrates a system 100 that stores unaligned data structures in memory, according to an example. The system 100 includes a processor 101 and external memory 105. The external memory could be cache, main memory, DDR, on-chip memory, off-chip memory, and the like.

The processor 101 uses an interface 110 to communicate with the memory 105. The interface 110 can vary depending on the implementation of the processor 101 and the memory 105. For example, the interface 110 could include a bus, chip-to-chip connection, a network on a chip (NoC), etc.

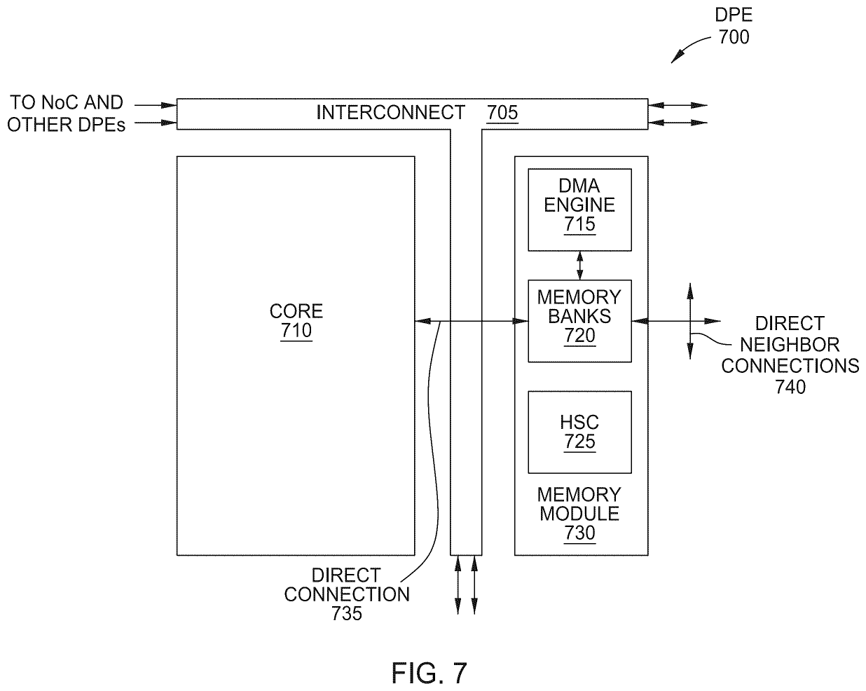

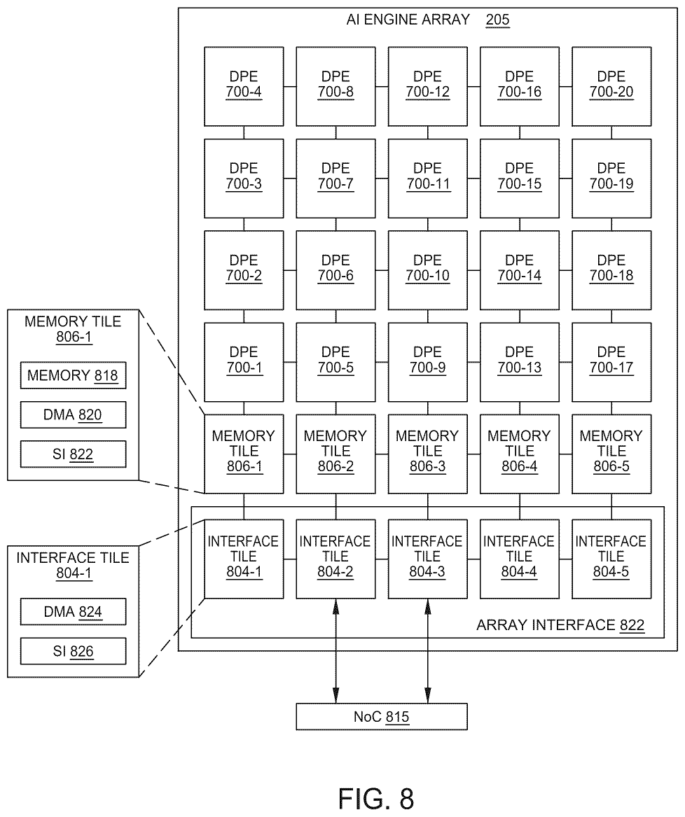

The processor 101 is not limited to a particular implementation and can apply to many different types of processors, such as central processing units (CPUs), graphical processing units (GPU), microprocessors, controllers, data processing engines (which are discussed in detail in FIGS. 7 and 8 below), and the like.

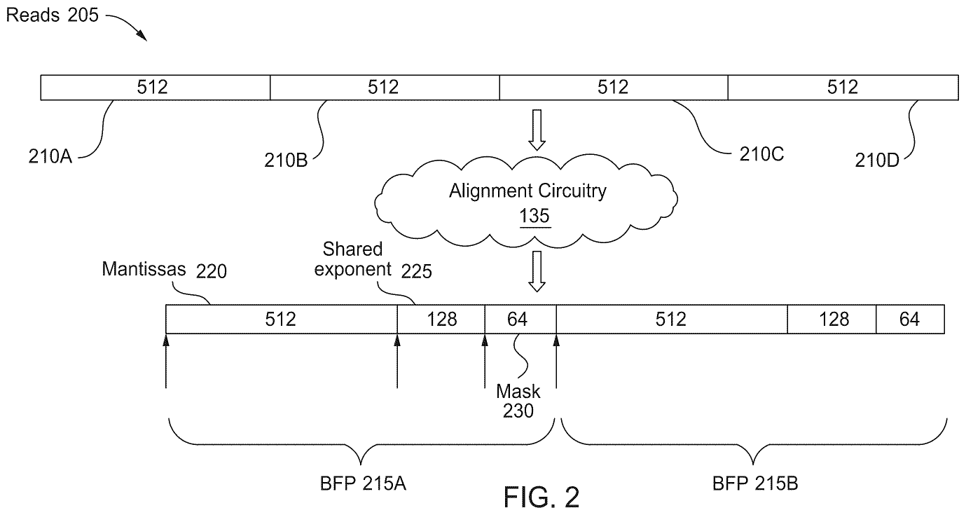

The processor 101 includes local memory 115 and a core 125. The local memory 115 can communicate with the memory 105 which is external to the processor. In this example, the local memory 115 stores unaligned data structures 120. That is, while the width or the bandwidth of the local memory may be a power of 2, the width or length of the unaligned data structures 120 is not. As such, the unaligned data structures 120 do not align with the width of local memory 115. For example, if the data chunks are 512 bits and the data structures 120 have a length of 704 bits, then even if the first bits of the data chunk and the data structure 120 are aligned, the end of the data structure 120 spills over into the next data chunk. That is, the first 192 bits of the next data chunk in the local memory 115 will include the last 192 bits of the data structure. The next data structure would start of bit 193 in the data chunk and then extend to bit 384 of the next data chunk. Examples of this will be described in more detail in FIG. 2 below. In this manner, the beginning and end bits of the data structures 120 may not align with the start and end bits of the data chunks that are read out of, or stored into, the local memory 115.

The core 125 includes at least one load unit 130 for reading the data chunks from the local memory 115. Because the data structures 120 are not aligned with the data chunks, the load unit 130 includes alignment circuitry 135 which can identify the starting bits of the various parts of the data structures 120, such as the mantissa, a shared exponent, masking bits, and the like. Once the data structures 120 are identified, the alignment circuitry 135 can store aligned data structures 145 in a register 140. That is, the width of the registers 140 may be the same as the length of the aligned data structures 145.

As such, while the registers 140 have the same width as the data structures 145, the local memory 115 does not. This may be advantageous since designing the local memory 115 to have the same width and bandwidth to match the data structures may use a considerable amount of area and additional power. Stated oppositely, using a local memory 115 that does not align with the data structures 120 can save area and power.

In another embodiment, the different portions of the data structures can be saved in separate buffers with widths that match those portions. For example, the mantissas of the data structure can be saved in one buffer, the shared exponent of the data structure could be saved in another buffer, masking bits in the data structure could be saved in another buffer, and so forth. However, this can put a significant burden on the software that manages pointers to these buffers, which makes programming the system more difficult.

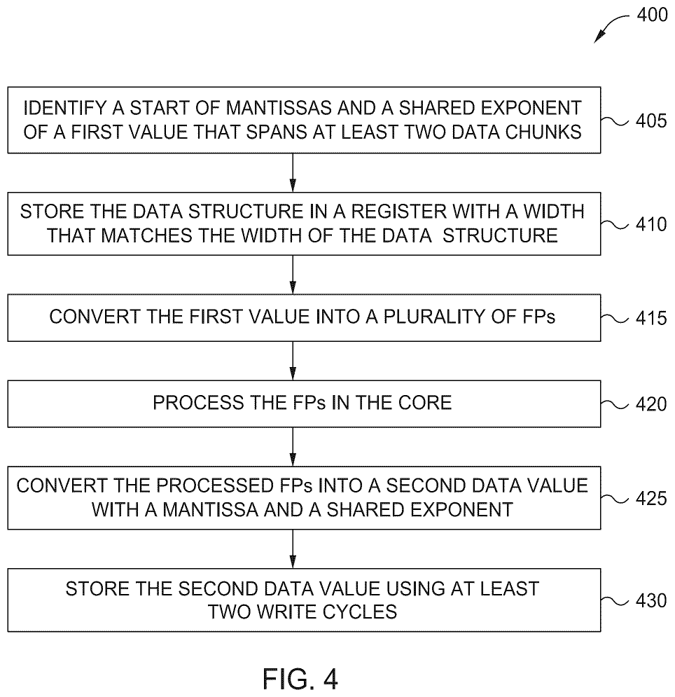

The data processing circuitry 150 can retrieve the aligned data structure 145 from the register 140 and process the data—e.g., perform a MAC operation or some other data operation. One example of processing the data is discussed in FIG. 4 below.

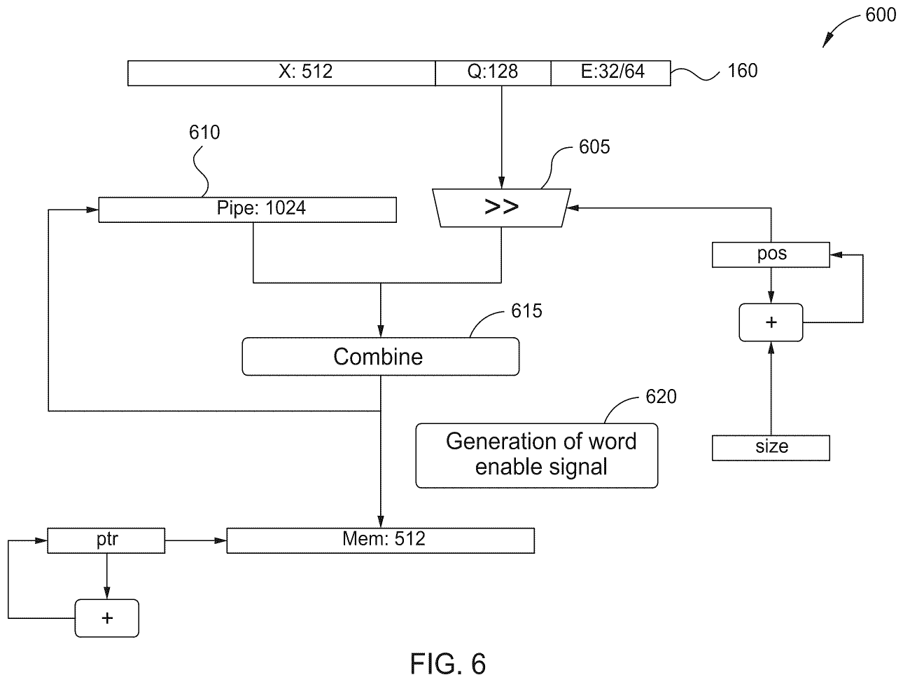

After processing the data, the results can be stored in a register 160 in the store unit 155 as aligned data structure 165. The store unit 155 can then store this data as unaligned data structures 120 in the local memory 115. Like above, when stored the aligned data structures 165 become unaligned with the data chunks used by the local memory 115 when data is stored into it. For example, the aligned data structures 165 may be stored into the local memory 115 using multiple data chunks (e.g., multiple 512 bit writes). This is discussed in more detail in FIG. 6.

FIG. 2 illustrates retrieving unaligned data structure from memory, according to an example. That is, FIG. 2 is one example of reading multiple data chunks from a memory (e.g., the local memory 115 in FIG. 1) and identifying an unaligned data structure in that memory. In this example, a load unit in a core performs multiple reads 205 from the local memory, and in response, receives the data chunks 210A-D. In this example, each read cycle provides 512 bits of data, indicating the bandwidth or the width of the memory.

The alignment circuitry 135 in the load unit identifies where each data structure begins in the data chunks 210. In this example, the unaligned data structures are BFPs 215 with sparsity bits. The alignment circuitry 135 receives the data chunks 210 and determines that the beginning of the BFP 215A is near the middle of the data chunk 210A. The BFP 215 includes a mantissa portion 220 which can include multiple different mantissas (e.g., 16 mantissas that are each 32 bits in length). The BFPs 215 also include a shared exponent 225 that is shared by the mantissas in the mantissa portion 220. In this example, the BFPs include masking bits 230 for a sparse mask. This mask can be used to indicate that some of the data values are zero. For example, the data structure may be used to represent values of a matrix. Instead of using multiple bits to represent a zero, the masking bits 230 can be used to indicate which values are zero, thereby serving as a form of data compression (when using sparse matrices). However, the masking bits 230 are optional. Further, the BFPs 215 can include other types of metadata besides the masking bits, such as type selector bits which may indicate the data type of the data structure (e.g., whether it is BFP, MXFP, INT, FP, etc.).

In this example, the length of each of the BFPs 215 is 704 bits which means they span across at least two of the data chunks 210 and can span across three of the data chunks 210, as is the case for BFP 215A which extends across data chunks 512A-C. This means the load unit performs three read cycles before it obtains all the data in the BFP 215A.

However, in other embodiments, the length of the BFPs (or any other data structure) may be less than a data chunk and still be unaligned with the memory—e.g., have start and end bits that do not align with the start and end bits of the data chunk, and/or not be a power of two. In that case, at least some of the data structures stored in the memory will still span two of the data chunks, while other may be contained within a single data chunk.

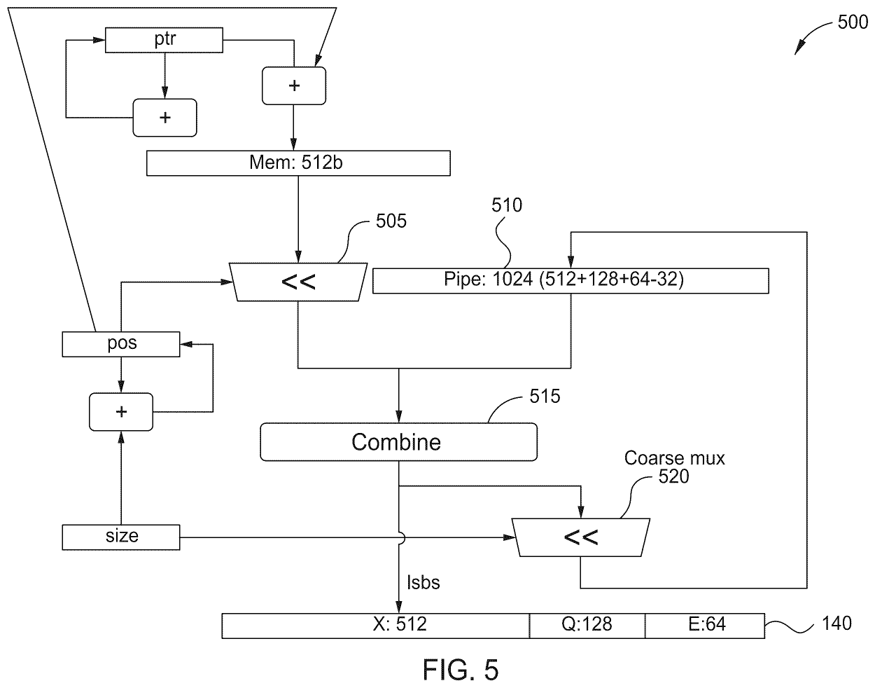

The alignment circuitry 135 can parse the data chunks to identify when one BFP 215 ends and other begins. As discussed in more detail in FIG. 5, once identified, the load unit can store the BFPs 215 in a register that has the same width—e.g., 704 bits in this example.

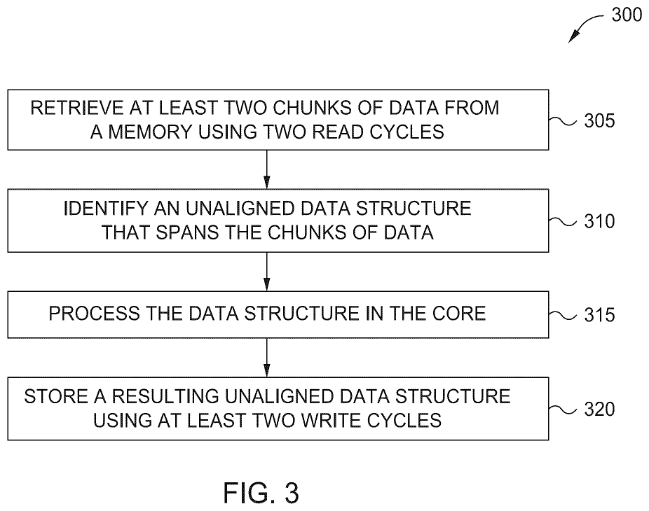

FIG. 3 is a flowchart of a method 300 for processing unaligned data structures in a core, according to an example. At block 305, a load unit receives at least two chunks of data from a memory using at least two read cycles. For example, the memory may be a local memory in a processor (e.g., local memory 115 in processor 101) which has a set bandwidth (e.g., provides 512 bits of data to the load unit during each read cycle).

In one embodiment, the at least two data chunks includes unaligned data structures that spans the two (or more) chunks. That is, the beginning/end bits of the data chunks may not always align with a beginning or end of the data structure. Examples of this were illustrated in FIG. 2 above.

At block 310, alignment circuitry in the load unit identifies an unaligned data structure that spans the chunks of data. For example, the alignment circuitry may identify a start of one or more mantissas in the data structure. One example of alignment circuitry is discussed in FIG. 5 below.

In one embodiment, the alignment circuitry stores in the data structure in a register that has a width that matches the length of the data structure.

At block 315, data processing circuitry (e.g., the circuitry 150 in FIG. 1) in the core of the processor processes the data structure. For example, the core may retrieve the data structure from the register in the load unit and perform any number of operations using the data, such as a MAC.

Further, in one embodiment, the core may convert the data structure to a different data structure before performing operations. For instance, the core may convert a BFP to a plurality of regular FPs before performing a MAC. This embodiment is discussed in more detail in FIG. 4 below.

Once processed, at block 320 the data processing circuitry stores a resulting data structure using at least two write cycles. For instance, after writing the resulting data structure to a register, a store unit in the core can use multiple write cycles to store the data structure into multiple data chunks in the local memory. As such, the data structures can have a different length or width as the local memory but still be stored in the local memory.

FIG. 4 is a flowchart of method 400 for processing data structures with a shared exponent in a core, according to an example. The method 400 describes storing unaligned data structures (when stored in memory) into a register that has a same width as the data structures. Further, the core can the convert the data structure into a different type of data structure before processing the data. Method 400 is described in the context of a data structure that includes several mantissas that have a shared exponent.

At block 405, alignment circuitry in a load unit identifies a start of mantissa and a shared exponent of a first data value that spans at least two data chunks. For example, the data value may be a BFP or a MXFP. This data value can include other information (e.g., metadata) besides the mantissas and shared exponents, such as sparsity (masking) bits, type selector bits, and the like.

At block 410, the alignment circuitry stores the data structure in a register with a width that matches the width of the data structure. This can be the same as block 310 of FIG. 3.

At block 415, the data processing circuitry in the core converts the first value into a plurality of FPs. For example, the first value may be a BFP that includes four mantissas and a shared exponent. This can be converted into four individual FP values, each with their own mantissa and an exponent. In this example, the hardware of the data processing circuitry may be designed to operate on FPs, rather than BFPs. As such a conversion can take place so that data is in a format that is compatible with the hardware of the data processing circuitry. Further, by storing the data in the BFP or MXFP format, this may save space (and save bandwidth when transferring the data between different memories) relative to storing the data as individual FPs in local memory.

At block 420, the data processing circuitry processes the FPs. This can include a MAC, or any other suitable operation.

At block 425, the data processing circuitry converts the processed FPs into a second data value with a mantissa and a shared exponent. For example, the data processing circuitry can convert multiple FPs back into, e.g., a single BFP or MXFP value.

At block 430, the store unit in the core stores the second data value using at least two write cycles, as discussed at block 320 of FIG. 2.

However, in another embodiment, the data processing circuitry might not convert the FPs back into a condensed data structure (e.g., a data structure with multiple mantissas and a shared exponent). Instead, the FPs may be stored into the local memory.

FIG. 5 illustrates logic 500 for retrieving unaligned data structures from a local memory, according to an example. That is, FIG. 5 illustrates one example of alignment circuitry 135 in the load unit 130 in FIG. 1. FIG. 5 illustrates a pointer (ptr) that provides addressed to data to be loaded from the local memory. FIG. 5 illustrates that the local memory has a bandwidth of 512 bits (i.e., 512 bits can retrieved from the local memory every read cycle) which includes BFP values with a length of 704 bits. However, this is just one illustrative example. In other embodiments, the bandwidth of the local memory can be a different power of two, while the unaligned data type can have a different length (such as a BFP with just 512 bits of mantissa and a 128 bit shared exponent, but no 64 bits of sparsity).

The address of the ptr does not have to been aligned with the start of the 512b word. The pointer can be a byte pointer to any byte within the 512 bit word. The pointer is incremented by the amount of data that is loaded by the store unit.

A byte level multiplexer (mux) 505 performs a left bit shift to concatenate the data received from the local memory with data already stored in a pipe 510 (e.g., a FIFO) from a previous read from the local memory. Combine circuitry 515 combines the data received from the mux 505 with the data from previous reads stored in the pipe 510. That is, the combine circuitry 515 concatenates the data.

During the first read, the pipe 510 is empty. In that case, the mux 505 shifts the 512b to the least significant bits (LSBs) of the pipe 510. Because the 512b provided by the mux 505 is not enough for the 704b BFP with sparsity, a coarse mux 520 stores the output of the combine circuitry 515 into the pipe 510. That is, the data is not written to the register 140. Moreover, this first read does not have to be aligned, and could start in the middle of 512b word. For example, 256 bits could have been received at the mux 505 and then loaded into the pipe 510 by the coarse mux 520.

On the second read, the 512 bits from the memory and the 512 bits from the pipe (assuming the first read was aligned with the start of the 512 bit word) are combined at the combine circuitry 515 which writes the 704 LSBs into the register 140. The coarse mux 520 stores the remaining 312 bits into the pipe 510, which can then be combined with the 512 bits retrieved from the memory in the third read, and so forth.

The position (pos) indicates how much data is in the pipe 510 so the logic 500 knows how much to bit shift the mux 505 so the data is added to the end of the data already in the pipe 510.

The size is the size of the unaligned data structure. If the same type of data is being stored in the local memory, the size may be fixed. However, in other embodiments the local memory may store multiple types of data type with different size (e.g., BFPs with sparsity bits and BFPs without sparsity bits). In that case, the size can fluctuate according to what data type is currently being read out from the local memory.

In one embodiment, a programmer can interleave pops (where data is read from the memory but not stored in the register 140 and only stored in the pipe 510) and fields (where data is read from the memory and is combined with data in the pipe 510 to write data into the register 140). This avoids underflow conditions where there is not enough data to fill the register 140.

Once the data is in the register 140, it can be retrieved by the data processing circuitry in the core. For example, blocks 415-425 of the method 400 in FIG. 4 can be performed.

FIG. 6 illustrates logic 600 for storing unaligned data structures into a local memory, according to an example. The logic 600 is one example of logic in the store unit 155 in FIG. 1 that stores an aligned data structure in the register 160 into local memory 115.

The contents of the register 160 are received by a byte level mux 605 that performs a right bit shift so that the data in the register 160 can be combined with data in a pipe 610 (e.g., a FIFO) saved from a previous write operation. Combine circuitry 615 is tasked with combining the data in the pipe 610 with the bit shifted data from the mux 605.

If the pipe 610 is currently empty, the 512 most significant bits (MSBs) from the 704 bits from the register 160 is written into local memory and the remainder is pushed into the pipe. On the second write, the data stored in the pipe 610 (e.g., 192 bits) is concatenated with the next 704 bits of the next BFP stored in the register 160. That is, the 192 bits in the pipe 610 is combined with 320 bits from the next BFP and stored in the memory. The remaining 384 bits are stored in the pipe 610.

As this continues, the pipe 610 would eventually fill up leading to an overflow. To avoid this, the programmer can interleave pushes (where data from both the pipe 610 and the data from the register 160 are stored in the memory) and flushes where only data from the pipe 610 (e.g., when the pipe 610 has at least 704 bits stored in it) is stored in the memory.

The logic 600 also includes circuitry 620 for generating word enable signals for activating particular bytes when writing to the local memory. For example, for each byte in the 512b word, the circuitry 620 can signal whether the combine circuitry 615 is (or is not) writing to that byte (where a byte can be 8 bits, 16 bits, 32 bits, etc.). For example, the logic 600 might want to write only to the beginning lanes of the 512b word. This is controlled by the value of the ptr. For example, the ptr may point to the middle of the 512b word so that the logic 600 writes only to 256 bits of the word so as not to overwrite the other half of the word which might have valid data.

FIG. 7 is a block diagram of a data processing engine (DPE) 700, according to an example. The DPE 700 is one example of a processor 101 in FIG. 1. The DPE 700 includes an interconnect 705, a core 710, and a memory module 730. The interconnect 705 permits data to be transferred from the core 710 and the memory module 730 to different cores in the array. That is, the interconnect 705 in each of the DPEs 700 may be connected to each other so that data can be transferred north and south (e.g., up and down) as well as east and west (e.g., right and left) between the DPEs 700 in the array.

For example, the DPEs 700 in an upper row of the array rely on the interconnects 705 in the DPEs 700 in a lower row to communicate with a NoC. For example, to transmit data to the NoC, a core 710 in a DPE 700 in the upper row transmits data to its interconnect 705 which is in turn communicatively coupled to the interconnect 705 in the DPE 700 in the lower row. The interconnect 705 in the lower row is connected to the NoC. The process may be reversed where data intended for a DPE 700 in the upper row is first transmitted from the NoC to the interconnect 705 in the lower row and then to the interconnect 705 in the upper row that is the target DPE 700. In this manner, DPEs 700 in the upper rows may rely on the interconnects 705 in the DPEs 700 in the lower rows to transmit data to and receive data from the NoC.

In one embodiment, the interconnect 705 includes a configurable switching network that permits the user to determine how data is routed through the interconnect 705. In one embodiment, unlike in a packet routing network, the interconnect 705 may form streaming point-to-point connections. That is, the streaming connections and streaming interconnects (not shown in FIG. 2) in the interconnect 705 may form routes from the core 710 and the memory module 730 to the neighboring DPEs 700 or the NoC. Once configured, the core 710 and the memory module 730 can transmit and receive streaming data along those routes. In one embodiment, the interconnect 705 is configured using the AXI Streaming protocol. However, when communicating with the NoC, the DPEs 700 may use the AXI MM protocol.

In addition to forming a streaming network, the interconnect 705 may include a separate network for programming or configuring the hardware elements in the DPE 700. Although not shown, the interconnect 705 may include a memory mapped interconnect (e.g., AXI MM) which includes different connections and switch elements used to set values of configuration registers in the DPE 700 that alter or set functions of the streaming network, the core 710, and the memory module 730.

In one embodiment, streaming interconnects (or network) in the interconnect 705 support two different modes of operation referred to herein as circuit switching and packet switching. In one embodiment, both of these modes are part of, or compatible with, the same streaming protocol—e.g., an AXI Streaming protocol. Circuit switching relies on reserved point-to-point communication paths between a source DPE 700 to one or more destination DPEs 700. In one embodiment, the point-to-point communication path used when performing circuit switching in the interconnect 705 is not shared with other streams (regardless whether those streams are circuit switched or packet switched). However, when transmitting streaming data between two or more DPEs 700 using packet-switching, the same physical wires can be shared with other logical streams.

The core 710 may include hardware elements for processing digital signals. For example, the core 710 may be used to process signals related to wireless communication, radar, vector operations, machine learning applications, and the like. As such, the core 710 may include program memories, an instruction fetch/decode unit, fixed-point vector units, floating-point vector units, arithmetic logic units (ALUs), multiply accumulators (MAC), and the like. However, as mentioned above, this disclosure is not limited to DPEs 700. The hardware elements in the core 710 may change depending on the engine type. That is, the cores in a AI engine, digital signal processing engine, cryptographic engine, or FEC may be different.

The memory module 730 includes a DMA engine 715, memory banks 720, and hardware synchronization circuitry (HSC) 725 or other type of hardware synchronization block. In one embodiment, the DMA engine 715 enables data to be received by, and transmitted to, the interconnect 705. That is, the DMA engine 715 may be used to perform DMA reads and write to the memory banks 720 using data received via the interconnect 705 from the NoC or other DPEs 700 in the array.

The memory banks 720 can include any number of physical memory elements (e.g., SRAM). For example, the memory module 730 may be include 4, 8, 16, 32, etc. different memory banks 720. In this embodiment, the core 710 has a direct connection 735 to the memory banks 720. Stated differently, the core 710 can write data to, or read data from, the memory banks 720 without using the interconnect 705. That is, the direct connection 735 may be separate from the interconnect 705. In one embodiment, one or more wires in the direct connection 735 communicatively couple the core 710 to a memory interface in the memory module 730 which is in turn coupled to the memory banks 720.

In one embodiment, the memory module 730 also has direct connections 740 to cores in neighboring DPEs 700. Put differently, a neighboring DPE in the array can read data from, or write data into, the memory banks 720 using the direct neighbor connections 740 without relying on their interconnects or the interconnect 705 shown in FIG. 7. The HSC 725 can be used to govern or protect access to the memory banks 720. In one embodiment, before the core 710 or a core in a neighboring DPE can read data from, or write data into, the memory banks 720, the core (or the DMA engine 715) requests a lock acquire to the HSC 725 when it wants to read or write to the memory banks 720 (i.e., when the core/DMA engine want to “own” a buffer, which is an assigned portion of the memory banks 720. If the core or DMA engine does not acquire the lock, the HSC 725 will stall (e.g., stop) the core or DMA engine from accessing the memory banks 720. When the core or DMA engine is done with the buffer, they release the lock to the HSC 725. In one embodiment, the HSC 725 synchronizes the DMA engine 715 and core 710 in the same DPE 700 (i.e., memory banks 720 in one DPE 700 are shared between the DMA engine 715 and the core 710). Once the write is complete, the core (or the DMA engine 715) can release the lock which permits cores in neighboring DPEs to read the data.

Because the core 710 and the cores in neighboring DPEs 700 can directly access the memory module 730, the memory banks 720 can be considered as shared memory between the DPEs 700. That is, the neighboring DPEs can directly access the memory banks 720 in a similar way as the core 710 that is in the same DPE 700 as the memory banks 720. Thus, if the core 710 wants to transmit data to a core in a neighboring DPE, the core 710 can write the data into the memory bank 720. The neighboring DPE can then retrieve the data from the memory bank 720 and begin processing the data. In this manner, the cores in neighboring DPEs 700 can transfer data using the HSC 725 while avoiding the extra latency introduced when using the interconnects 705. In contrast, if the core 710 wants to transfer data to a non-neighboring DPE in the array (i.e., a DPE without a direct connection 740 to the memory module 730), the core 710 uses the interconnects 705 to route the data to the memory module of the target DPE which may take longer to complete because of the added latency of using the interconnect 705 and because the data is copied into the memory module of the target DPE rather than being read from a shared memory module.

In addition to sharing the memory modules 730, the core 710 can have a direct connection to cores 710 in neighboring DPEs 700 using a core-to-core communication link (not shown). That is, instead of using either a shared memory module 730 or the interconnect 705, the core 710 can transmit data to another core in the array directly without storing the data in a memory module 730 or using the interconnect 705 (which can have buffers or other queues). For example, communicating using the core-to-core communication links may use less latency (or have high bandwidth) than transmitting data using the interconnect 705 or shared memory (which requires a core to write the data and then another core to read the data) which can offer more cost effective communication. In one embodiment, the core-to-core communication links can transmit data between two cores 710 in one clock cycle. In one embodiment, the data is transmitted between the cores on the link without being stored in any memory elements external to the cores 710. In one embodiment, the core 710 can transmit a data word or vector to a neighboring core using the links every clock cycle, but this is not a requirement.

In one embodiment, the communication links are streaming data links which permit the core 710 to stream data to a neighboring core. Further, the core 710 can include any number of communication links which can extend to different cores in the array. In this example, the DPE 700 has respective core-to-core communication links to cores located in DPEs in the array that are to the right and left (east and west) and up and down (north or south) of the core 710. However, in other embodiments, the core 710 in the DPE 700 illustrated in FIG. 7 may also have core-to-core communication links to cores disposed at a diagonal from the core 710. Further, if the core 710 is disposed at a bottom periphery or edge of the array, the core may have core-to-core communication links to only the cores to the left, right, and bottom of the core 710.

However, using shared memory in the memory module 730 or the core-to-core communication links may be available if the destination of the data generated by the core 710 is a neighboring core or DPE. For example, if the data is destined for a non-neighboring DPE (i.e., any DPE that DPE 700 does not have a direct neighboring connection 740 or a core-to-core communication link), the core 710 uses the interconnects 705 in the DPEs to route the data to the appropriate destination. As mentioned above, the interconnects 705 in the DPEs 700 may be configured when the SoC is being booted up to establish point-to-point streaming connections to non-neighboring DPEs to which the core 710 will transmit data during operation.

FIG. 8 is a block diagram of an AI engine array 805, according to an example. In this example, AI engine array 805 includes a plurality of circuit blocks, or tiles, illustrated here as the DPEs 700 (also referred to as DPE tiles or compute tiles), interface tiles 804, and memory tiles 806. Memory tiles 806 may be referred to as shared memory and/or shared memory tiles. Interface tiles 804 may be referred to as shim tiles, and may be collectively referred to as an array interface 828. Like in FIG. 2, the AI engine array 805 is coupled to the NoC 815. FIG. 8 further illustrates that the interface tiles 804 communicatively couple the other tiles in the AI engine array 805 (i.e., the DPEs 700 and memory tiles 806) to the NoC 815.

DPEs 700 can include one or more processing cores, program memory (PM), data memory (DM), DMA circuitry, and stream interconnect (SI) circuitry, which are also described in FIG. 4. For example, the core(s) is the DPEs 700 can execute program code stored in the PM. The core(s) may include, without limitation, a scalar processor and/or a vector processor. DM may be referred to herein as local memory or local data memory, in contrast to the memory tiles which have memory that is external to the DPE tiles, but still within the AI engine array 805.

The core(s) may directly access data memory of other DPE tiles via DMA circuitry. The core(s) may also access DM of adjacent (or neighboring) DPEs 700 via DMA circuitry and/or DMA circuitry of the adjacent compute tiles. In one embodiment, DM in one DPE 700 and DM of adjacent DPE tiles may be presented to the core(s) as a unified region of memory. In one embodiment, the core(s) in one DPE 700 may access data memory of non-adjacent DPEs 700. Permitting cores to access data memory of other DPE tiles may be useful to share data amongst the DPEs 700.

The AI engine array 805 may include direct core-to-core cascade connections (not shown) amongst DPEs 700. Direct core-to-core cascade connections may include unidirectional and/or bidirectional direct connections. Core-to-core cascade connections may be useful to share data amongst cores of the DPEs 700 with relatively low latency (e.g., the data does not traverse stream interconnect circuitry such as the interconnect 705 in FIG. 7, and the data does not need to be written to data memory of an originating DPE and read by a recipient or destination DPE). For example, a direct core-to-core cascade connection may be useful to provide results from an accumulation register of a processing core of an originating DPE directly to a processing core(s) of a destination DPE.

In an embodiment, DPEs 700 do not include cache memory. Omitting cache memory may be useful to provide predictable/deterministic performance. Omitting cache memory may also be useful to reduce processing overhead associated with maintaining coherency among cache memories across the DPEs 700.

In an embodiment, processing cores of the DPE 700 do not utilize input interrupts. Omitting interrupts may be useful to permit the processing cores to operate uninterrupted. Omitting interrupts may also be useful to provide predictable and/or deterministic performance.

One or more DPEs 700 may include special purpose or specialized circuitry, or may be configured as special purpose or specialized compute tiles such as, without limitation, digital signal processing engines, cryptographic engines, forward error correction (FEC) engines, and/or artificial intelligence (AI) engines.

In an embodiment, the DPEs 700, or a subset thereof, are substantially identically to one another (i.e., homogenous compute tiles). Alternatively, one or more DPEs 700 may differ from one other more other DPEs 700 (i.e., heterogeneous compute tiles).

Memory tile 806-1 includes memory 818 (e.g., random access memory or RAM), DMA circuitry 820, and stream interconnect (SI) circuitry 822.

Memory tile 806-1 may lack or omit computational components such as an instruction processor. In an embodiment, memory tiles 806, or a subset thereof, are substantially identical to one another (i.e., homogenous memory tiles). Alternatively, one or more memory tiles 806 may differ from one other more other memory tiles 806 (i.e., heterogeneous memory tiles). A memory tile 806 may be accessible to multiple DPEs 700. Memory tiles 806 may thus be referred to as shared memory.

Data may be moved between/amongst memory tiles 806 via DMA circuitry 820 and/or stream interconnect circuitry 822 of the respective memory tiles 806. Data may also be moved between/amongst data memory of a DPE 700 and memory 818 of a memory tile 806 via DMA circuitry and/or stream interconnect circuitry of the respective tiles. For example, DMA circuitry in a DPE 700 may read data from its data memory and forward the data to memory tile 806-1 in a write command, via stream interconnect circuitry in the DPE 700 and stream interconnect circuitry 822 in the memory tile 806. DMA circuitry 824 of memory tile 806-1 may then write the data to memory 818. As another example, DMA circuitry 820 of memory tile 806-1 may read data from memory 818 and forward the data to a DPE 700 in a write command, via stream interconnect circuitry 822 and stream interconnect circuitry in the DPE 700, and DMA circuitry in the DPE 700 can write the data to its data memory.

Array interface 828 interfaces between the AI engine array 805 (e.g., DPEs 700 and memory tiles 806) and the NoC 815. Interface tile 804-1 includes DMA circuitry 824 and stream interconnect circuitry 826. Interface tiles 804 may be interconnected so that data may be propagated amongst interface tiles 804 bi-directionally. An interface tile 804 may operate as an interface for column of DPEs 700 (e.g., as an interface to the NoC 815). Interface tiles 804 may be connected such that data may be propagated from one interface tile 804 to another interface tile 804 bi-directionally.

In an embodiment, interface tiles 804, or a subset thereof, are substantially identically to one another (i.e., homogenous interface tiles). Alternatively, one or more interface tiles 804 may differ from one other more other interface tiles 804 (i.e., heterogeneous interface tiles).

In an embodiment, one or more interface tiles 804 is configured as a NoC interface tile (e.g., as master and/or slave device) that interfaces between the DPEs 700 and the NoC 815 (e.g., to access other components in the SoC). While FIG. 8 illustrates coupling a subset of the interface tiles 804 to the NoC 815, in one embodiment, each of the interface tiles 804-1-5 is connected to the NoC 815. Doing so may permit different applications to control and use different columns of the memory tiles 806 and DPEs 700.

DMA circuitry and stream interconnect circuitry of the AI engine array 805 may be configurable/programmable to provide desired functionality and/or connections to move data between/amongst DPEs 700, memory tiles 806, and the NoC 815. The DMA circuitry and stream interconnect circuitry of the AI engine array 805 may include, without limitation, switches and/or multiplexers that are configurable to establish signal paths within, amongst, and/or between tiles of the AI engine array 805. The AI engine array 805 may further include configurable AXI interface circuitry. The DMA circuitry, the stream interconnect circuitry, and/or AXI interface circuitry may be configured or programmed by storing configuration parameters in configuration registers, configuration memory (e.g., configuration random access memory or CRAM), and/or eFuses, and coupling read outputs of the configuration registers, CRAM, and/or eFuses to functional circuitry (e.g., to a control input of a multiplexer or switch), to maintain the functional circuitry in a desired configuration or state. In an embodiment, the core(s) of DPEs 700 configure the DMA circuitry and stream interconnect circuitry of the respective DPEs 700 based on core code stored in PM of the respective DPEs 700. A controller (not shown) can configure DMA circuitry and stream interconnect circuitry of memory tiles 806 and interface tiles 804 based on controller code.

The AI engine array 805 may include a hierarchical memory structure. For example, data memory of the DPEs 700 may represent a first level (L1) of memory, memory 818 of memory tiles 806 may represent a second level (L2) of memory, and external memory outside the AI engine array 805 may represent a third level (L3) of memory. Memory capacity may progressively decrease with each level (e.g., memory 818 of memory tile 806 may have more storage capacity than data memory in the DPEs 700, and external memory may have more storage capacity than data memory 818 of the memory tiles 806). The hierarchical memory structure is not, however, limited to the foregoing examples.

As an example, an input tensor may be relatively large (e.g., 1 megabyte or MB). Local data memory in the DPEs 700 may be significantly smaller (e.g., 64 kilobytes or KB). The controller may segment an input tensor and store the segments in respective blocks of shared memory tiles 806.

In the preceding, reference is made to embodiments presented in this disclosure. However, the scope of the present disclosure is not limited to specific described embodiments. Instead, any combination of the described features and elements, whether related to different embodiments or not, is contemplated to implement and practice contemplated embodiments. Furthermore, although embodiments disclosed herein may achieve advantages over other possible solutions or over the prior art, whether or not a particular advantage is achieved by a given embodiment is not limiting of the scope of the present disclosure. Thus, the preceding aspects, features, embodiments and advantages are merely illustrative and are not considered elements or limitations of the appended claims except where explicitly recited in a claim(s).

As will be appreciated by one skilled in the art, the embodiments disclosed herein may be embodied as a system, method or computer program product. Accordingly, aspects may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium is any tangible medium that can contain, or store a program for use by or in connection with an instruction execution system, apparatus or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described below with reference to flowchart illustrations and/or block diagrams of methods, apparatus (systems) and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods, and computer program products according to various examples of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the foregoing is directed to specific examples, other and further examples may be devised without departing from the basic scope thereof, and the scope thereof is determined by the claims that follow.

What is claimed is:

1. A processor, comprising:
a memory configured to store unaligned data structures;
a load unit comprising circuitry configured to:
receive at least two data chunks from the memory using respective read cycles,
identify an unaligned data structure within the at least two data chunks, and
store the unaligned data structure in a register, wherein the unaligned data structure spans across the at least two data chunks and does not align with the at least two data chunks; and
data processing circuitry in a core of the processor configured to retrieve the unaligned data structure from the register and process the unaligned data structure.

2. The processor of claim 1, wherein start and end bits of the unaligned data structure do not align with start and end bits of the at least two data chunks.

3. The processor of claim 2, wherein the unaligned data structure has a length that is greater than a length of each of the at least two data chunks.

4. The processor of claim 1, wherein the unaligned data structures each comprise a plurality of mantissas and a shared exponent, wherein a length of each of the unaligned data structures is not a power of two.

5. The processor of claim 4, wherein the unaligned data structures each comprise metadata.

6. The processor of claim 4, wherein the unaligned data structures are one of a block floating points (BFP) or microscaling floating points (MXFP).

7. The processor of claim 4, wherein the data processing circuitry is configured to convert the unaligned data structure into a plurality of floating points using the plurality of mantissas and the shared exponent.

8. The processor of claim 1, further comprising:
a store unit configured to store the unaligned data structure, after being processed by the data processing circuitry, into the memory using at least two data chunks and at least two write cycles.

9. The processor of claim 1, wherein the register has a same width as the unaligned data structure.

10. A core, comprising:
a load unit configured to retrieve data from a memory that stores unaligned data structures, the load unit comprising circuitry configured to:
receive at least two data chunks from the memory using respective read cycles,
identify an unaligned data structure within the at least two data chunks, and
store the unaligned data structure in a register, wherein the unaligned data structure spans across the at least two data chunks and does not align with the at least two data chunks; and
data processing circuitry configured to retrieve the unaligned data structure from the register and process the unaligned data structure.

11. The core of claim 10, wherein start and end bits of the unaligned data structure do not align with start and end bits of the at least two data chunks.

12. The core of claim 11, wherein the unaligned data structure has a length that is greater than a length of each of the at least two data chunks.

13. The core of claim 10, wherein the unaligned data structures each comprise a plurality of mantissas and a shared exponent, wherein a length of the unaligned data structures is not a power of two.

14. The core of claim 13, wherein the unaligned data structures each comprise metadata.

15. The core of claim 13, wherein the unaligned data structures are one of a block floating points (BFP) or microscaling floating points (MXFP).

16. The core of claim 13, wherein the data processing circuitry is configured to convert the unaligned data structure into a plurality of floating points using the plurality of mantissas and the shared exponent.

17. The core of claim 10, further comprising:
a store unit configured to store the unaligned data structure, after being processed by the data processing circuitry, into the memory using at least two data chunks and at least two write cycles.

18. The core of claim 10, wherein the register has a same width as the unaligned data structure.

19. A method comprising:
receiving, at a load unit, at least two data chunks from a memory using respective read cycles, wherein the memory stores unaligned data structures;
identifying an unaligned data structure within the at least two data chunks;
storing the unaligned data structure in a register, wherein the unaligned data structure spans across the at least two data chunks and does not align with the at least two data chunks; and
retrieving the unaligned data structure from the register and processing the unaligned data structure using circuitry in a core.

20. The method of claim 19, wherein start and end bits of the unaligned data structure do not align with start and end bits of the at least two data chunks.
